(19) United States
(12) Patent Application Publication
(10) Pub. No.: US 2008/0116609 A1
(43) Pub. Date: May 22, 2008

(54) In-Situ Molding Of Fuel Cell Separator Plate Reinforcement

(76) Inventor: Joseph B. Darke, Dover, TN (US)

Correspondence Address: MARSHALL & MELHORN, LLC, FOUR SEAGATE, 8TH FLOOR, TOLEDO, OH, 43804, US

(21) Appl. No.: 11/795,053

(22) PCT Filed: Jan. 10, 2006
(86) PCT No.: PCT/IB06/50091

§ 371 Date: Jul. 9, 2007

Related U.S. Application Data
(60) Provisional application No. 60/642,651, filed on Jan. 10, 2005.

(51) Int. Cl. B29B 13/00; B29C 45/14

(52) U.S. Cl. 264/271.1; 264/272.11

(57) ABSTRACT

A method for making a reinforced composite separator plate is disclosed. According to the method, a reinforcement media (16) is molded into a composite material (22, 24) such as graphite embedded in a thermoplastic or thermosetting polymer resin matrix. The composite material is placed in a mold cavity (15, 17) such that the composite material flows through the reinforcement media. The separator plate is molded into a net step. The molding is performed via injection or compression moulding, or a combination of both.

This application claims the benefit of U.S. Provisional Application No. 60/642,651, filed on Jan. 10, 2005, the entirety of which is hereby incorporated by reference.

### TECHNICAL FIELD

Separator plates for fuel cell stacks, and more specifically, reinforcement media for separator plates, are disclosed and described.

### BACKGROUND ART

A fuel cell is a device that converts the chemical energy of fuels directly to electrical energy and heat. In its simplest form, a fuel cell comprises two electrodes—an anode and a cathode—separated by an electrolyte. During operation, a gas distribution system supplies the anode and the cathode with fuel and oxidizer, respectively.

Typically, fuel cells use the oxygen in the air as the oxidizer and hydrogen gas (including hydrogen produced by reforming hydrocarbons) as the fuel. Other viable fuels include reformulated gasoline, methanol, ethanol, and compressed natural gas, among others. For polymer electrolyte membrane (‘PEM’) fuel cells, each of these fuels must be reformed into hydrogen fuel. However, in direct methanol fuel cells, methanol itself is the fuel. The fuel undergoes oxidation at the anode, producing protons and electrons. The protons diffuse through the electrolyte to the cathode where they combine with oxygen and the electrons to produce water and heat. Because the electrolyte acts as a barrier to electron flow, the electrons travel from the anode to the cathode via an external circuit containing a motor or other electrical load that consumes power generated by the fuel cell.

A complete fuel cell generally includes a pair of separator plates or separator plate assemblies on either side of the electrolyte. A conductive backing layer may also be provided between each plate and the electrolyte to allow electrons to move freely into and out of the electrode layers. Besides providing mechanical support, the plates define fluid flow paths within the fuel cell and collect current generated by oxidation and reduction of the chemical reactants. The plates are gas-impermeable and have channels or grooves formed on one or both surfaces facing the electrolyte. The channels distribute fluids (gases and liquids) entering and leaving the fuel cell, including fuel, oxidizer, water, and any coolants or heat transfer liquids. Each separator plate may also have one or more apertures extending through the plate that distribute fuel, oxidizer, water, coolant and any other fluids throughout a series of fuel cells. Each separator plate is typically made of an electron conducting material including graphite, aluminum or other metals, and composite materials such as graphite particles imbedded in a thermosetting or thermoplastic polymer matrix. To increase their energy delivery capability, fuel cells are typically provided in a stacked arrangement of pairs of separator plates with electrolyte between each plate pair. In this arrangement, one side of a separator plate will be positioned adjacent to and interface with the anode of one fuel cell, while the other side of the separator plate will be positioned adjacent to and interface with the cathode of another fuel cell. Thus, the plate is referred to as ‘bipolar.’

Typical separator plates include an anode flow path on one surface and a cathode flow path on another surface. The plates may be integrally formed with both the anode and cathode surfaces. Alternatively, an anode plate and cathode plate may be separately formed and then combined to create a separator plate assembly. As indicated above, coolant channels are typically formed by the assembly process, due to grooves on one plate mating with a flat surface or matching grooves on the other plate.

Known composite separator plates for fuel cell stacks have become quite thin resulting in more fragile plates. In addition, the apertures mentioned above define manifold holes for supply of reactants and product removal. These areas are particularly vulnerable to cracks. Accordingly, improving the strength of the separator plate would improve the manufacturability of these plates.

SUMMARY OF THE EMBODIMENTS

A method of manufacturing a reinforced separator plate comprises providing a mold cavity, providing a composite material, providing a reinforcement, and placing the reinforcement media in the mold cavity. The method further comprises placing the composite material in the mold cavity such that the composite material flows through the reinforcement media, and molding the separator plate into a net shape.

In one embodiment, the molding is performed via injection molding. In another embodiment, the molding is performed via compression molding. In other embodiments, the reinforcement media is carbon fiber cloth. In still other embodiments, the carbon fiber cloth is pre-impregnated with binder resin. In further embodiments, the reinforcement media is selected from fiberglass, metal, plastic, and metal screens. In yet other embodiments, the reinforcement media is pre-impregnated with a predetermined amount of composite material necessary to manufacture the separator plate.

### DESCRIPTION OF DRAWINGS

FIG. 1 is a front elevational view of an embodiment of a fuel cell separator plate.

FIG. 2 is a schematic drawing of a first embodiment of a molding process for making a fuel cell separator plate; and

FIG. 3 is a schematic drawing of a second embodiment of a molding process for making a fuel cell separator plate.

### DETAILED DESCRIPTION

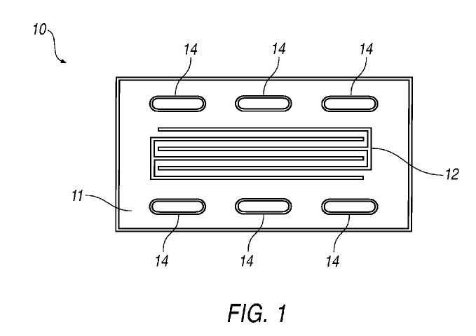

Referring to FIG. 1, an embodiment of a typical fuel cell separator plate 10 is described. As described in detail below, plate 10 is preferably formed by in-situ molding with a reinforcement. Plate 10 may have any one of a variety of desired or ‘net’ (i.e., final) shapes and configurations, and the specific embodiment of FIG. 1 is meant to be exemplary only. Plate 10 preferably comprises an anode surface 11, as well as an opposing cathode surface 13 (not shown). Plate 10 may comprise an integrally formed plate having both an anode surface and a cathode surface. Alternatively, separate anode and cathode plates may be formed and then attached to one another, such as by an adhesive or mechanical fastener. When used in a stacked fuel cell arrangement, anode surface 11 is positioned adjacent a first fuel cell anode, and cathode surface 13 is positioned adjacent a second fuel cell cathode.

Anode surface 11 preferably includes a structure 12 for distributing gases and liquids entering and leaving the fuel cell (e.g., hydrogen entering the fuel cell). To ratably and evenly distribute such materials, structure 12 preferably comprises channels or grooves. It may also include one or more apertures 14 that cooperate with apertures on other separator plates to define a manifold for distributing fuel, oxidizer, water, coolant and any other fluids throughout a series of cells. Cathode surface 13 may be configured similarly to anode surface 11 with its own set of grooves or channels (e.g., for distributing oxygen entering the cell and/or water leaving it).

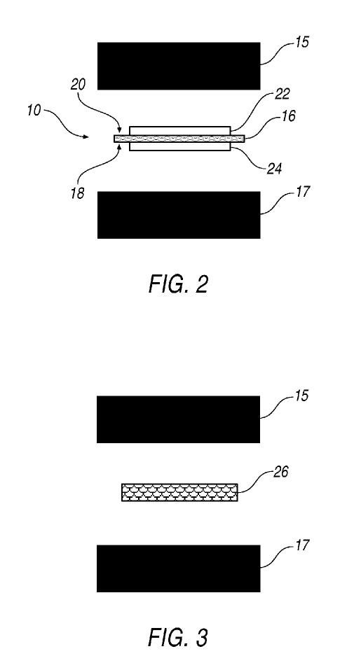

Referring to FIG. 2, a first embodiment of a method of making a fuel cell separator plate such as plate 10 will now be described. The method can be used to form a single separator plate having both an anode surface and a cathode surface. It can also be used to form separate anode and cathode plates that form part of a separator plate assembly.

Separator plate 10 may have the configuration depicted in FIG. 1 or any other con- figuration suitable for use in a fuel cell. In accordance with the embodiment, a mold comprising first half 15 and second half 17 is provided. In FIG. 2, side elevation views of mold halves 15 and 17 are illustrated. Although not shown, each mold half 15 and 17 includes an internal cavity that is shaped to define a desired pattern on separator plate 10. For example, if each side of separator plate 10 will include grooves such as grooves 12 shown in FIG. 1, then the cavity of each mold half 15 and 17 will define a corresponding groove pattern. If apertures 14 are desired, the respective mold cavities will also define those.

Separator plate portions 22 and 24 preferably comprise preforms that are the same size or smaller than their respective mold half cavities. Portions 22 and 24 are preferably made of an electron conducting composite material such as graphite particles imbedded in a thermoplastic or thermosetting polymer resin matrix. Composite materials comprising graphite particles imbedded in a vinyl ester matrix are especially preferred. The width of reinforcement 16 is preferably the same or greater than that of separator plate portions 22 and 24. In the embodiment of FIG. 2 reinforcement 16 is wider than separator plate portions 22 and 24.

Reinforcement 16 may be conductive or non-conductive. However, it is preferably conductive and lightweight. It also at least somewhat permeable to the material forming separator plate portions 22 and 24. In one exemplary embodiment, reinforcement 16 comprises carbon fiber cloth. However, other materials such as paper, fiberglass, metal, plastic screens, or metal screens may be used. If non-conductive materials are used, reinforcement 16 is preferably configured with an open area that allows separator plate portions 22 and 24 to remain in electrical contact with one another. In another embodiment, non-conductive materials with a relatively coarse mesh size may be used. The mesh size is preferably selected to allow composite material to flow through it, providing for electrical contact between separator plate portions 22 and 24 in the open area of the mesh. In one exemplary embodiment, the open ara of each individual mesh ranges from about 1/16 sq. in. to about 1 sq. in. (from about 0.40 sq.cm. to about 6.45 sq. cm).

In one embodiment, reinforcement 16 is placed between separator plate portions 22 and 24 and compression molded between mold halves 15 and 17. Separator plate portion 22 is positioned adjacent a first surface 20 of reinforcement 16, and separator plate portion 24 is positioned adjacent a second surface 18 of reinforcement 16. Sepa rator plate portions 22 and 24 preferably flow through reinforcement 16 during the molding process so reinforcement 16 is molded into the desired net-shape of separator plate 10. In another embodiment, reinforcement 16 is placed between mold halves 15 and 17, and composite material used to form separator plate portions 22 and 24 is injection molded around and through reinforcement 16. A combination of injection and compression molding (injection-compression molding) may also be used. Also, reinforcement 16 need not be sandwiched between separate volumes of composite material, such as those defined by separator plate portions 22 and 24, but instead, may be molded with composite material on only one side of it.

In an alternative embodiment of the method depicted in FIG. 2, prior to molding, reinforcement 16 is pre-impregnated or coated with a quantity of the polymer resin, such as the resin used to form separator plate portions 22 and 24. Pre-impregnation aids in the wetting of reinforcement 16 and generally improves the uniformity of molding.

Referring to FIG. 3, an alternate embodiment of a method for making separator plate 10 is depicted. As with the previous embodiment, this embodiment can be used to form a separator plate having both an anode surface and a cathode surface. It can also be used to form an anode plate or cathode plate that forms part of a separator plate assembly.

In accordance with the method, pre-impregnated reinforcement 26 is provided. Pre-impregnated reinforcement 26 preferably comprises a reinforcement (not separately shown in FIG. 3) made of materials such as those described above with respect to reinforcement 16 of FIG. 2. The reinforcement is preferably pre-impregnated with an electrically conductive composite material such as graphite particles imbedded in a thermoplastic or thermosetting polymer resin matrix. Unlike the previous embodiments, the quantity of composite material used to pre-impregnate the reinforcement is preferably sufficient to form the entire separator plate, such that no additional composite material need be added to pre-impregnated reinforcement 26. Pre-impregnated reinforcement 26 is then placed between mold halves 15 and 17 and molded into the desired shape.

A variety of different molding temperatures and times may be used with the foregoing embodiments depending on the specific materials used and the desired product properties. However, the temperature is preferably at least sufficient to cure the composite material comprising the separator plate. The curing time may range from less than about one (1) minute to several minutes. However, for manufacturing purposes, the curing time is preferably less than about one (1) minute.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A method of manufacturing a reinforced separator plate, comprising the steps of:
providing a mold cavity;
providing composite material;
providing a reinforcement media;
placing said reinforcement media in said mold cavity;
placing said composite material in said mold cavity such that said composite material flows through said reinforcement media; and
molding the separator plate into a net shape.

2. The method of claim 1, wherein said molding is performed via injection molding.

3. The method of claim 1, wherein said molding is performed via compression molding.

4. The method of claim 1, wherein said reinforcement media is carbon fiber cloth.

5. The method of claim 4, wherein said carbon fiber cloth is pre-impregnated with binder resin.

6. The method of claim 1, wherein said reinforcement media is one selected from fiberglass, metal, plastic screens, and metal screens.

7. The method of claim 1, wherein said reinforcement media is pre-impregnated with a predetermined amount of composite material necessary to manufacture the separator plate.

8. The method of claim 1, wherein said molding is performed via injection-compression molding.

9. The method of claim 1, wherein the reinforcement media is impregnated with resin.
